(19) United States
(12) Patent Application Publication
(10) Pub. No.: US 2005/0198438 A1
(43) Pub. Date: Sep. 8, 2005

(54) Shared-memory multiprocessor

(76) Inventor: Hidetaka Aoki, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/065,259

(22) Filed: Feb. 25, 2005

(30) Foreign Application Priority Data
Mar. 4, 2004 (JP) 2004-060149

(51) Int. Cl. G06F 12/00

(52) U.S. Cl. 711/133; 711/145

(57) ABSTRACT

It is possible to simplify a transaction for maintaining cache coherency in a shared-memory multiprocessor. A directory is provided that has a bit train indicating, for each of the pages of a main memory, whether the page is registered in a cache of each node group (zero when not registered). A processor has an instruction to clear a directory entry corresponding to a specified page to zero. A contracting device monitors a transaction for maintaining cache coherency that flows through an interconnection network, and it detects bits in the directory that can be set to zero.

### CLAIM OF PRIORITY

The present application claims priority from Japanese application JP 2004-060149, filed on Mar. 4, 2004, the content of which is hereby incorporated by reference into this application.

### FIELD OF THE INVENTION

The present invention relates in general to a shared-memory multiprocessor; and, more particularly, the invention relates to a shared-memory multiprocessor that may be suitably used to build a high-speed parallel computer system of the shared memory type.

### BACKGROUND OF THE INVENTION

In recent years, a multiprocessor (SMP, Symmetric Multiprocessor) configuration has become widespread in host machines of personal computers (PC) and workstations (WS), as well as in server machines, and it has become an important theme to share a memory among a large number of 20 to 30 or more processors to increase the system performance. Although a shared bus is widely used as a method of configuring a multiprocessor of the shared memory type, the number of connectable processors can be no more than eight in such case, because, when the number of processors exceeds eight, the bus tends to become bottlenecked and the bus throughput is poor. Therefore, the use of a shared bus is not suitable as a method of connecting a large number of processors.

Existing methods of configuring a shared-memory multiprocessor, in which a large number of processors are connected, fall roughly into two systems. In one system, the shared-memory multiprocessor uses crossbar switches. Such a configuration is disclosed in “STARFIRE: Extending the SMP Envelope” IEEE Micro, January-February 1998, Vol. 18, Issue 1, pages 39-49, for example. In this system, boards, each having a processor and a main memory, are connected by high-speed crossbar switches to maintain cache coherency among the processors. This system is advantageous in that cache consistency can be maintained at high speed. However, since a transaction for maintaining cache coherency is broadcast to all processors, heavy traffic occurs in the crossbar switches so as to cause a bottleneck in the performance, and the need for high-speed switches causes an increase in the cost of the system as well. Furthermore, since the transaction for maintaining cache coherency must be broadcast, it is difficult to build a system of this type with a large number of processors; therefore, the number of processors is no more than several tens.

On the other hand, in another system, the multiprocessor uses a directory. An example of this system is disclosed in “Stanford FLASH Multiprocessor” (21st ISCA Proceedings), for example. This system is provided with a directory having a bitmap indicating, for each of the cache blocks of a main memory, in which processor a data duplicate of the cache block is cached, whereby a transaction for maintaining cache coherency is sent to only the required processors. With this construction, traffic on switches can be significantly reduced, contributing to a reduction in the switch hardware costs. However, the directory system has a disadvantage in that the storage area where the directory is located becomes large. For example, a directory of a system having 16 processors, a main memory of 4 GB and 128 bytes per line requires a storage area of 64 MB (=4 GB÷128 bytes×16 bits).

To address the problem of the large directory size, methods of reducing the size of a directory are disclosed in JP-A No. 311820/1997, JP-A No. 263374/1996, and JP-A No. 200403/1995. According to these methods, a directory is provided which indicates in which processor a data duplicate is cached, for each of the blocks which is larger than the cache blocks of a main memory.

The following problem exists in the above-mentioned technology to provide a directory which indicates in which processor a data duplicate is cached, for each of the blocks which is larger than the cache blocks of a main memory. For example, consider the case where the size of a cache block is 128 bytes and an entry of a directory is provided for each of the pages having a size of 4 KB (kilobytes) each. In this case, even when a certain processor registers only one cache block of a certain page in a cache, a transaction for maintaining cache coherency for the other cache blocks contained in the page is sent to the processor. Also, even if a cache block which has been registered in a cache is deregistered, it is difficult to detect the fact that, after the cache block is deregistered from the cache, all cache blocks contained in the page are not registered in the cache. As a result, to a processor that has once effected registration in the cache, from then en, a transaction for maintaining cache coherency for a page containing the registered cache block will be sent, causing a reduction in the performance.

An object of the present invention is to eliminate a reduction in the performance which occurs due to continued sending of a transaction for maintaining cache coherency for a page to a processor that has once registered a data duplicate of a cache block within the page in a cache, even when a directory is provided that records positional information of caches in which data duplicates of cache blocks within a page may exist, for each of the pages which are larger than the cache blocks of a main memory.

A shared-memory multiprocessor, in accordance with a typical embodiment of the present invention, includes plural processors, each having a cache capable of storing data duplicates of a plurality of first-size cache blocks of a main memory, and a directory that has entries respectively corresponding to data blocks (pages) of a second size of the main memory, the second size being a natural multiple (2 or greater) of the first size. The plural processors are divided into plural processor groups, each including at least one processor, each entry of the directory contains a train of bits respectively corresponding to the processor groups, and the train of bits indicates whether a data duplicate of any of the cache blocks belonging to corresponding data blocks is or is not stored in a cache memory of any of the processors belonging to the processor groups. A single instruction starts the operation to rewrite a train of bits of an entry corresponding to a specified data block of the directory, so as to indicate that data duplicates of cache blocks belonging to the specified data block are not stored in the cache memories of any processor groups.

Furthermore, a directory contracting device is provided that performs the steps of: detecting that one of the processor groups performs an operation to guarantee that, for all cache blocks belonging to a certain data block, a data duplicate is stored in only the cache memories of the processor group and not in the cache memories of other processor groups, and that other processor groups do not perform an operation for registering the data duplicates of the first-size blocks belonging to the second-size block in the caches; setting only a bit corresponding to the processor group within a train of bits of an entry corresponding to the detected data block of the directory to indicate that a data duplicate of any of the cache blocks belonging to the detected data block is stored in a cache memory of any of these processors; and setting other bits to indicate that data duplicates of any cache blocks belonging to the detected data block are not stored in the caches of any processors belonging to a corresponding processor group.

By means of the present invention, positional information of a cache in which a data duplicate may exist, recorded in a directory as a result of registration in the cache, can be deleted from the directory by issuance of an intentional instruction or by automatic detection by the directory contracting device. Thereby, even when a directory is adopted that provides for pages larger than the cache blocks of a main memory, it is possible to eliminate, at an early stage, the need to send a transaction for maintaining cache coherency for all cache blocks of a page to a processor that has registered a cache block within the page in a cache, and it is possible to eliminate a reduction in performance due to increased internode traffic.

### BRIEF DESCRIPTION OF THE DRAWINGS

FIG. 1 is a schematic block diagram of a shared-memory multiprocessor according to an embodiment of the present invention;

FIG. 2 is a diagram showing the structure of a node group table;

FIG. 3 is a diagram showing the structure of a directory;

FIG. 4 is a diagram showing part of the formats of commands flowing through an interconnection network;

FIG. 5 is a diagram showing part of the formats of commands flowing through an interconnection network;

FIG. 6 is a diagram showing part of the formats of commands flowing through an interconnection network;

FIG. 7 is a flowchart showing the flow of the processing of a system at the time of system startup;

FIG. 8 is a flowchart showing the flow of the processing of a receive filter;

FIG. 9 is a part of a flowchart showing the flow of the processing of a CCC device;

FIG. 10 is part of a flowchart showing the flow of the processing of a CCC device;

FIG. 11 is part of a flowchart showing the flow of the processing of a CCC device;

FIG. 12 is part of a flowchart showing the flow of the processing of a CCC device;

FIG. 13 is part of a flowchart showing the flow of the processing of a CCC device;

FIG. 14 is part of a flowchart showing the flow of the processing of a CCC device;

FIG. 15 is a flowchart showing the flow of the processing of a PF mechanism for a PageFlush instruction;

FIG. 16 is a flowchart showing the flow of the processing of a PF mechanism when a PF command is received;

FIG. 17 is a flowchart showing the flow of the processing of a PP mechanism for a PagePurge instruction;

FIG. 18 is a flowchart showing the flow of the processing of a PP mechanism when a PP command is received;

FIG. 19 is a flowchart showing the flow of the processing of a contracting device; and

FIG. 20 is a diagram of a table used for selecting an operation in a contracting device.

### DETAILED DESCRIPTION OF THE PREFERRED EMBODIMENTS

Hereinafter, preferred embodiments of the present invention will be described in detail with reference to the accompanying drawings.

(1) Outline of a Device

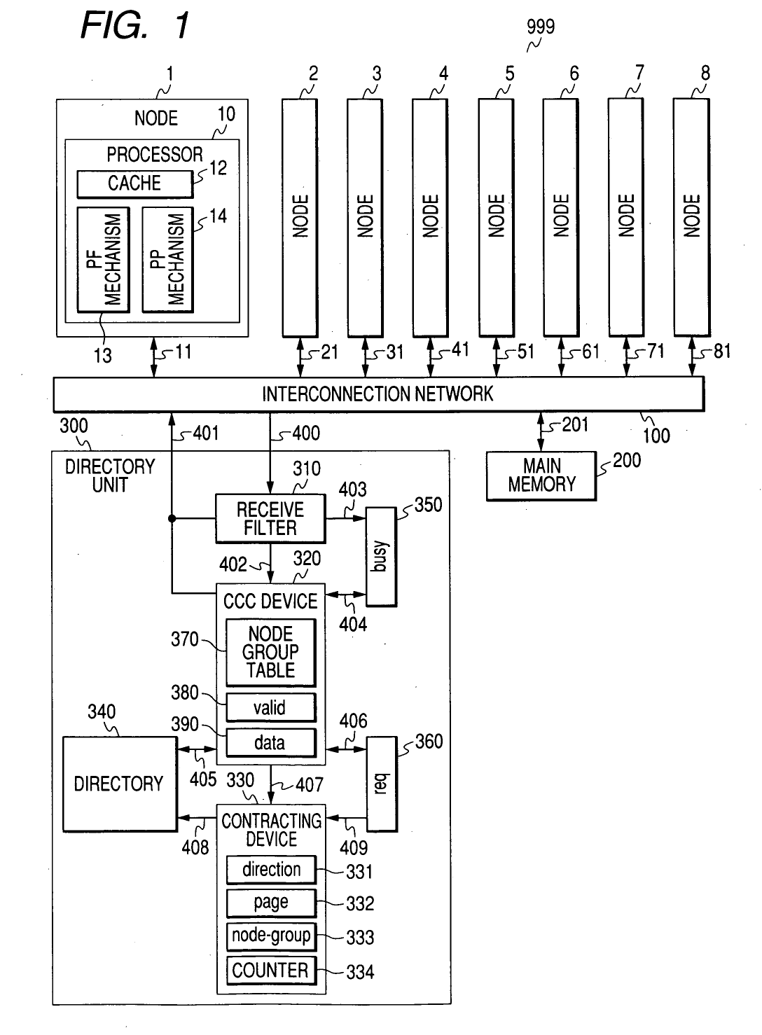

FIG. 1 is a block diagram showing the configuration of a shared-memory multiprocessor 999 (hereinafter referred to as a system 999) according to one embodiment of the present invention. The system comprises nodes 1 to 8, a main memory 200, and a directory unit 300. Those elements are mutually connected by an interconnection network 100. The nodes 1 to 8 are connected to the interconnection network 100 through lines 11, 21, 31, 41, 51, 61, 71, and 81, respectively. The main memory 200 is connected to the interconnection network 100 through a line 201. The directory unit 300 is connected to the interconnection network 100 through lines 400 and 401. Although the interconnection network 100 of this embodiment is a crossbar network, other interconnection methods may be employed. The interconnection network 100 will not be described in detail because it involves known technology.

The nodes 1 to 8 have the same structure, and each of the nodes has a processor 10. Although each node includes only one processor in this embodiment, nodes may include plural processors, and the number of processors included in each node may be-different. The system 999 is a parallel computer of the so-called shared-memory type in which all processors can access the main memory 200.

The processor 10 includes a cache 12, a PF (Page Flush) mechanism 13, and a PP (Page Purge) mechanism 14. The cache 12 is managed in units of cache blocks of 128 bytes each, and cache coherency control is achieved by MESI protocol that performs management by four states (Modified (M), Exclusive (E), Shared (S), and Invalid (I)). The cache coherency control according to the MESI protocol is detailed in the article by Tom Shanley, entitled “Pentium Pro Processor System Architecture” (MINDSHARE INC., 1997), pages 133-176, for example.

The directory unit 300 includes a receive filter 310, a CCC (Cache Coherency Control) device 320, a contracting device 330, a directory 340, a busy storage area 350, and a req storage area 360.

The CCC device 320 includes a node group table 370, a valid storage area 380, and a data storage area 390. The interconnection network 100 and the receive filter 310 are connected through the line 400; the receive filter 310, the CCC device 320, and the interconnection network 100 are connected through the line 401; the receive filter 310 and the CCC device 320 are connected through the line 402; the receive filter 310 and the busy storage area 350 are connected through the line 403; the CCC device 320 and the busy storage area 350 are connected through the line 404; the CCC device 320 and the directory 340 are connected through the line 405; the CCC device 320 and the req storage area 360 are connected through the line 406; the CCC device 320 and the contracting device 330 are connected through the line 407; the contracting device 330 and the directory 340 are connected through the line 408; and the req storage area 360 and the contracting device 330 are connected through the line 409.

The contracting device 330 includes a direction storage area 331, a page storage area 332, a node-group storage area 333, and a counter 334.

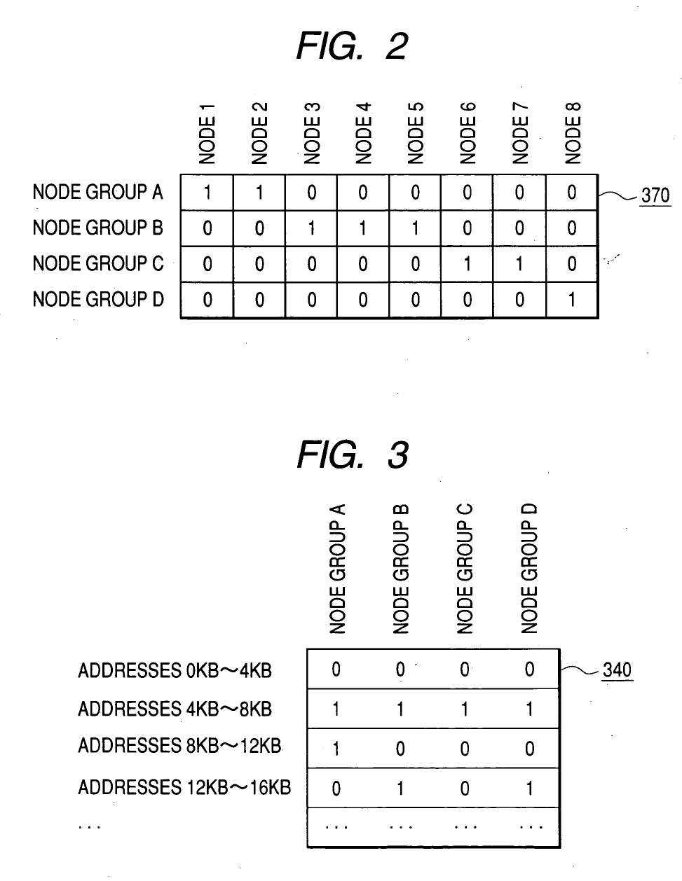

In the system 999, one or plural nodes are handled as one node group. Each of the nodes 1 to 8 belongs to one node group. The system 999 can handle up to four node groups A, B, C, and D. A node group is handled as one-bit information in each entry of the directory 340 to be described later. When the directory unit 300 transmits a command for cache coherency control to a certain node group, it transmits the command to all nodes belonging to the node group. The correspondence relation between nodes and node groups is set in the node group table 370. The node group table 370 is set during system startup. FIG. 2 shows the structure of the node group table 370. The node group table 370 is a two-dimensional table that comprises dimensions representative of node groups and dimensions representative of nodes. When a certain node belongs to a certain node group, the intersection of the node and the node group is one, and the other portions all are zero. For example, FIG. 2 shows that nodes 1 and 2 form a node group A, nodes 3 to 5 form a node group B, nodes 6 and 7 form a node group C, and node 8 forms a node group D.

The directory 340 will be described with reference to FIG. 3. The directory 340 is a table holding information on each of the memory blocks of 4 KB (kilobytes), each called pages, that indicates, in a cache of which node group, at least one cache block of a relevant page may exist. Since the directory is managed in a page unit of 4 KB, the necessary capacity can be reduced to 1/32(=128 bytes/4 KB) in comparison with the case where it is managed in a cache block unit of 128 bytes. Each directory entry consists of four bits, which correspond to a node group A, a node group B, a node group C, and a node group D, sequentially from the leftmost bit. When a certain bit of a directory entry is one, it indicates that at least one cache block belonging to a relevant page may be cached in any of the nodes of a node group corresponding to the bit. When the bit is zero, it indicates that none of the cache blocks belonging to a relevant page is cached in nodes belonging to a node group corresponding to the bit. All bits of the directory 340 are set at the value zero during system startup.

(2) Commands Flowing through the Interconnection Network

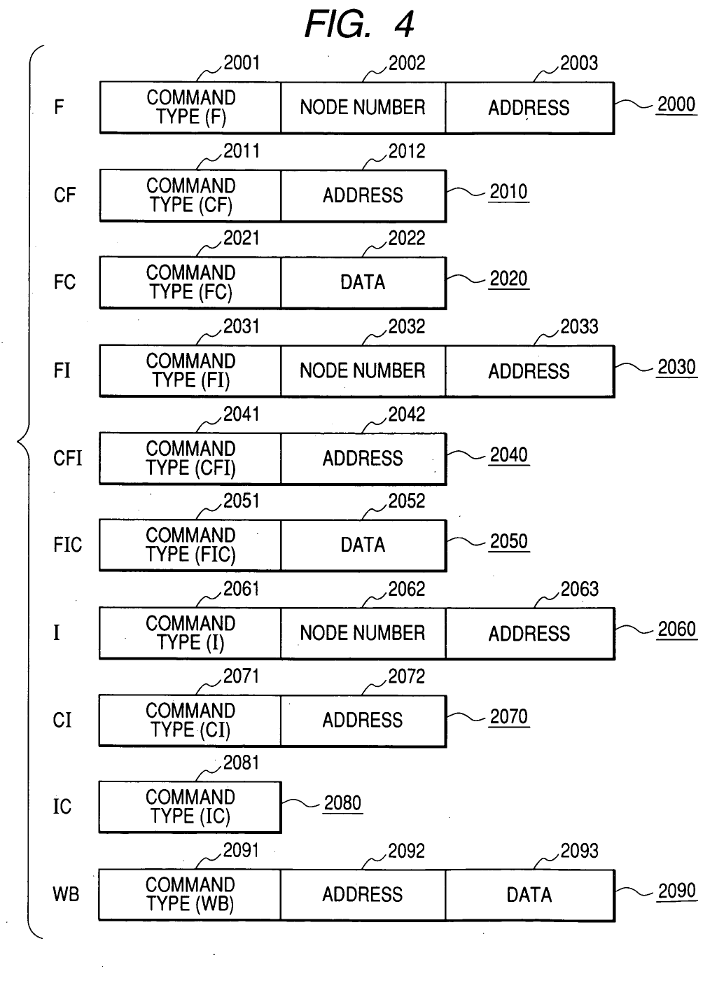

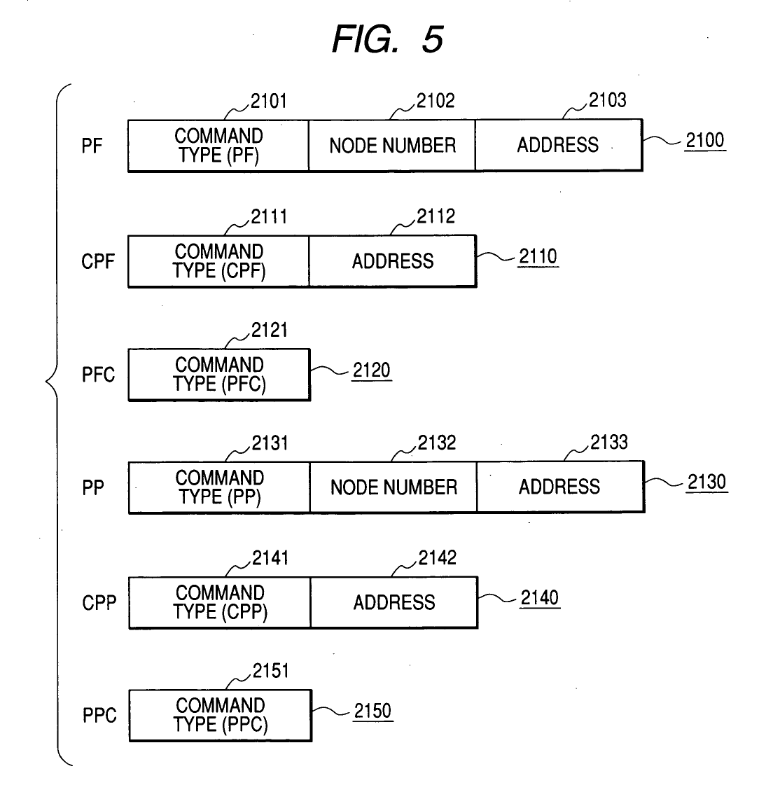

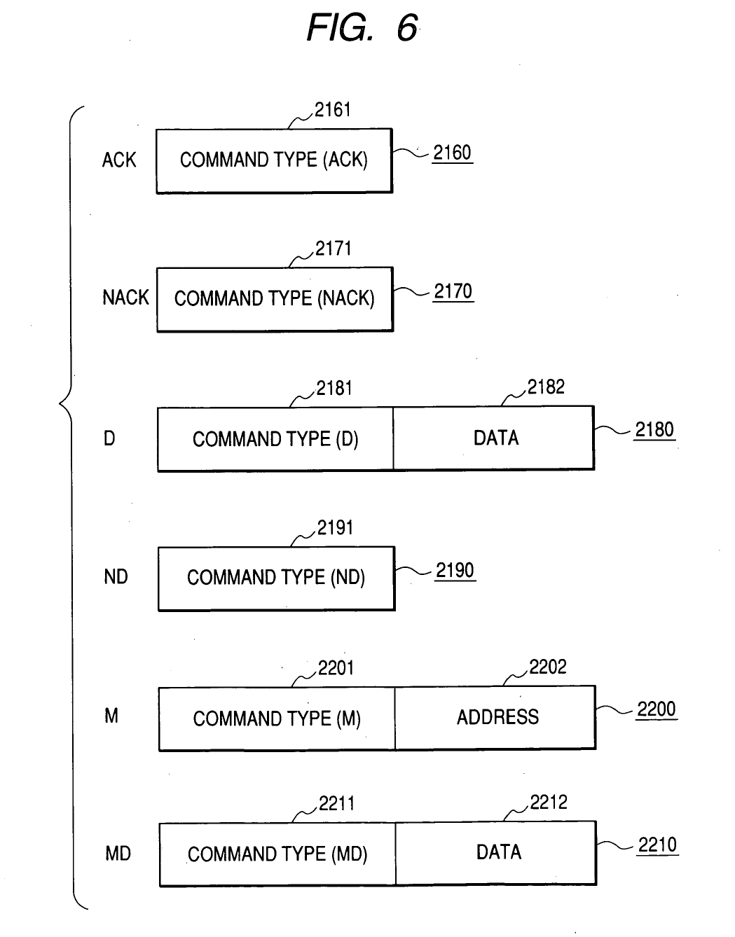

With reference to FIGS. 4 to 6, the commands flowing through the interconnection network will be described. The following twenty-two types of commands flow through the interconnection network: F command 2000, CF command 2010, FC command 2020, FI command 2030, CFI command 2040, FIC command 2050, I command 2060, CI command 2070, IC command 2080, WB command 2090, PF command 2100, CPF command 2110, PFC command 2120, PP command 2130, CPP command 2140, PPC command 2150, ACK command 2160, HACK command 2170, D command 2180, ND command 2190, H command 2200, and ND command 2210.

The size of each of the following command types is 4 bytes: 2001, 2011, 2021, 2031, 2041, 2051, 2061, 2071, 2081, 2091, 2101, 2111, 2121, 2131, 2141, 2151, 2161, 2171, 2181, 2191, 2201, and 2211.

The size of each of the following node numbers is 4 bytes: 2002, 2032, 2062, 2102, and 2132.

The size of each of the following addresses is 8 bytes: 2003, 2012, 2033, 2042, 2063, 2072, 2092, 2103, 2112, 2133, 2142, 2202.

Each of the following data has a cache block size of 128 bytes: 2022, 2052, 2093, 2182, and 2212.

The functions and the operation of the commands will be described later.

(3) Details of the Operation

(3-1) Operation at the Time of System Startup

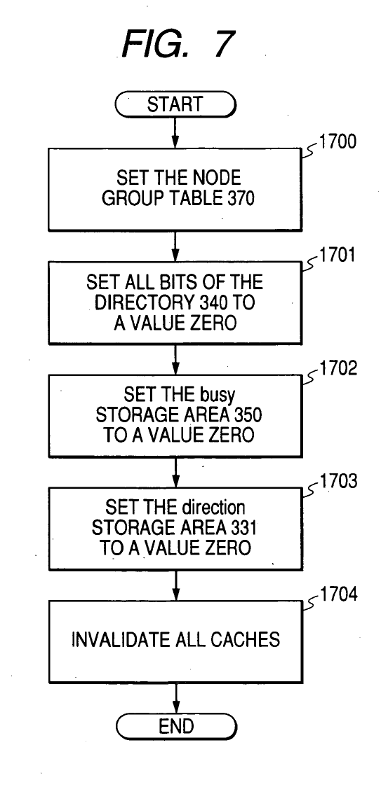

With reference to a flowchart of FIG. 7, the operation of the system at the time of system startup will be described.

In step 1700, the node group table 370 is set according 10 to the setting of a node group. In step 1701, all bits of the directory 340 are set at the value zero. In step 1702, the value zero is set in the busy storage area. In step 1703, the value zero is set in the direction storage area. In step 1704, all caches in the system 999 are nullified, and the startup of the system 999 terminates.

(3-2) Operation of the Receive Filter

With reference to the flowchart of FIG. 3, the flow of the operation of the receive filter 310 will be described for the case in which the directory unit 300 receives, via the line 400, a command that is transmitted over the interconnection network 100.

In step 1000, the receive filter 310 receives a command transmitted via the line 400. In step 1001, the receive filter 310 checks the type of the received command. When the received command is a F, FI, I, PF or PP command, it proceeds to step 1002. On the other hand, when the received command is other than a F, FI, I, PF, and PP command, it proceeds to step 1005.

In step 1002, the receive filter 310 reads the busy storage area 350 via the line 403, and, in step 1003, it determines whether the value of the read busy storage area 350 is one. If the value of the busy storage area 350 is one, the receive filter 310 proceeds to step 1006 to transmit a NACK command 2170 to a command transmission node indicated in the node number field in the command, and then the processing returns to step 1000. If the value of the 10 busy storage area 350 is not one, the receive filter 310 proceeds to step 1004 to set the busy storage area to one via the line 403 and to transmit an ACK command 2160 to the command transmission node indicated in the node number field in the command, and then the processing proceeds to step 1005.

In step 1005, the receive filter 310 transfers the received command to the CCC device 320, and the processing returns to step 1000.

(3-3) Operation of the CCC Device when a Processor Issues F Command

When a data read instruction executed by the processor 10 causes a cache miss, it is necessary to transfer the data of a relevant cache block to the cache 12 and to register the cache block as having state S. Accordingly, the processor 10 sets its own node number in the node number field 2002 of the F command 2000 and sets the address of the relevant cache block in the address field 2003, and it transmits the command to the directory unit 300 via the interconnection network 100. After that, the processor 10 waits for an ACK command 2160 or a NACK command 2170 to be transmitted from the directory unit 300. When receiving a NACK command 2170, the processor 10 retransmits the F command 2000 until it receives the ACK command 2160 without receiving the NACK command 2170. Upon receiving the ACK command 2160, the processor 10 halts the execution of the following instructions until it receives an FC command 2020.

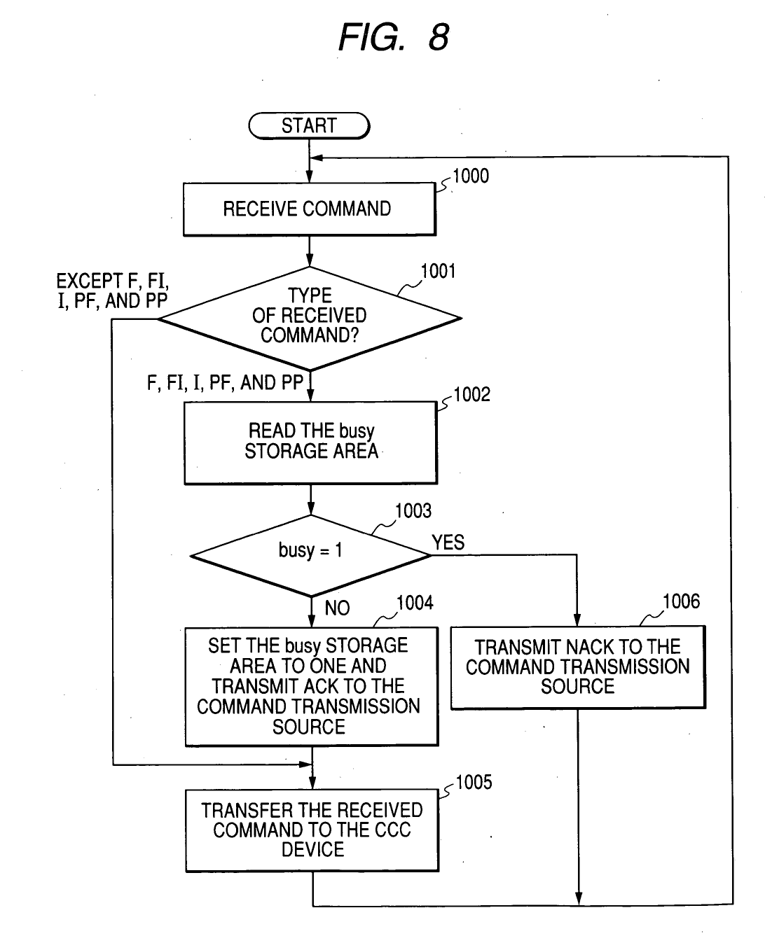

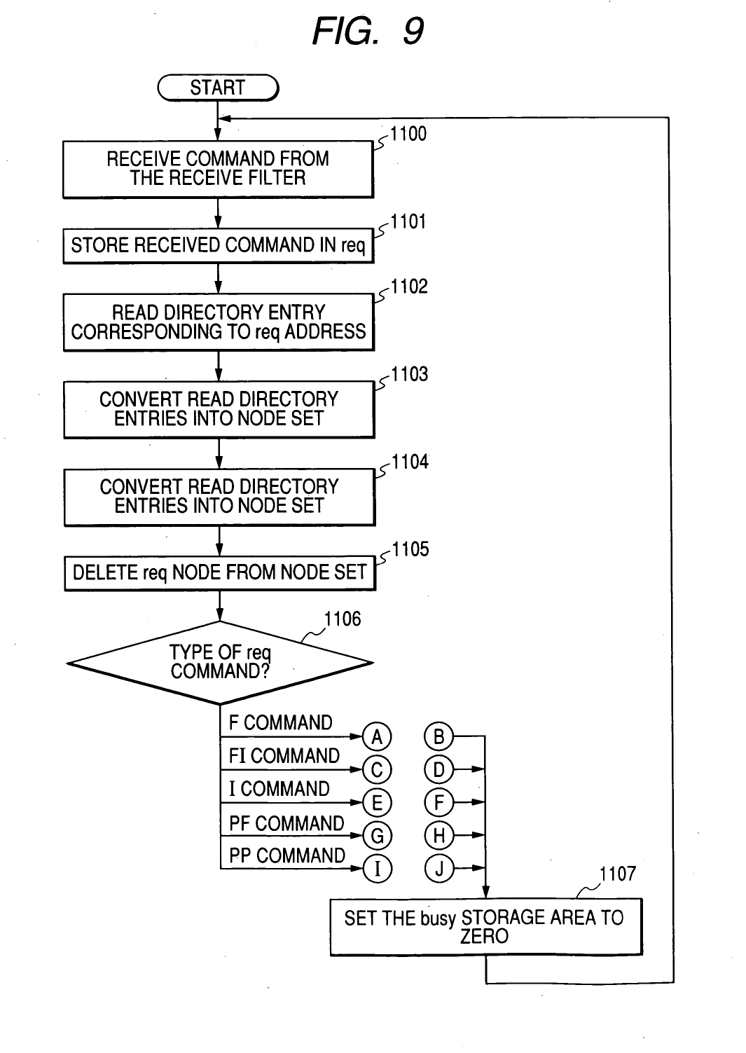

In the directory unit which has received the F command 2000, the receive filter 310 operates according to the flowchart of FIG. 8 (the description of which is omitted since it has already been described), and in step 1005, it transfers the received F command 2000 to the CCC device 320.

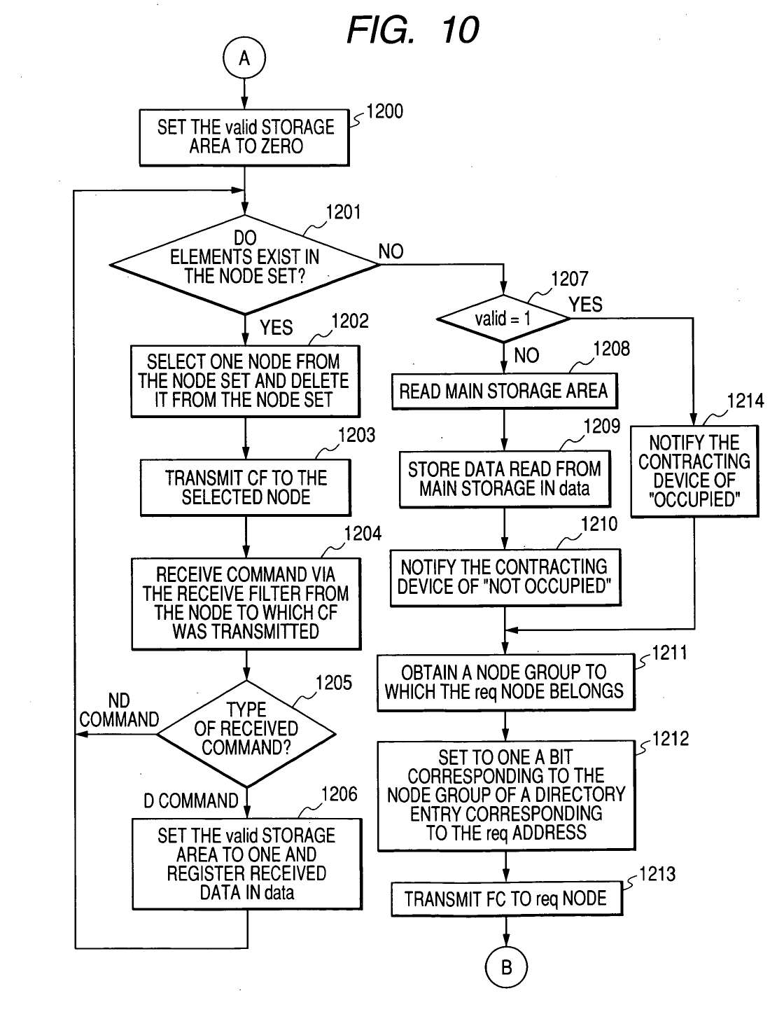

The operation of the CCC device 320 will be described with reference to the flowcharts of FIGS. 9 and 10.

In step 1100, the CCC device 320 receives the F command 2000 that was transferred from the receive filter 310. In step 1101, it records the received F command 2000 in the req storage area 360 via the line 406. In step 1102, it reads a directory entry corresponding to the address 2003 (req address) of the F command 2000 recorded in the req storage area 360. In step 1103, it converts the read directory entry into a node set. The node set, which refers to a set of nodes belonging to node groups corresponding to bits set to one in the directory entries, can be obtained by reference to the node group table 370. For example, when a directory entry has a value of 1010, it is determined from the node group table 370 that the nodes belonging to a node group 1, corresponding to the first one bit from the left of the directory entry, are nodes 1 and 2, and the nodes belonging to a node group 3, corresponding to the third one bit from the left of the directory entry are nodes 6 and 7. That is, a node set is made up of nodes 1, 2, 6, and 7. In step 1106, the CCC device 320 deletes the node number 2002 (req node) of the F command 2000 that is recorded in the req storage area 360 from the node set. In step 1106, it proceeds to step 1200 by determining the command type 2001 of the F command 2000 that is recorded in the req storage area 360.

In step 1200, it sets the valid storage area 380 at the value zero. In step 1201, it determines whether elements exist in the node set, and, if elements exist in the node set, it proceeds to step 1202; otherwise, it proceeds to step 1207.

In step 1202, it selects one node from the node set, and it deletes the selected node from the node set. In step 1203, it sets the req address in the address 2012, and it transmits the CF command 2010 to the selected node.

Upon receiving the CF command 2010, the node checks to determine whether the address 2012 is registered in its own cache. If the address 2012 indicates its own cache and the cache block is in the M state, the node causes the cache block to transition to the S state, sets the data of the cache block in the data 2182, and transmits the D command 2180 to the directory unit 300. If the address 2012 indicates its own cache and the cache block is in the E state, the node causes the cache block to transition to the S state, sets the data of the cache block in the data 2182, and it transmits the D command 2180 to the directory unit 300. If the address 2012 indicates its own cache and the cache block is in the S state, the node sets the data of the cache block in the data 2182, and it transmits the D command 2180 to the directory unit 300. If the address 2012 indicates its own cache and the cache block is in the I state, or the address 2012 is not registered in the cache, the node transmits an ND command 2190 to the directory unit 300. The D command 2180 or ND command 2190, which has been transmitted to the directory unit 300, is transferred to the CCC device 320 via the receive filter 310. The operation of the receive filter 310 will not be described here because it has already been described.

Here, the system returns to the operation of the CCC device 320. In step 1204, the CCC device 320 receives the D command 2180 or the ND command 2190. In step 1205, it determines the type of the received command. If the command is a D command 2180, it proceeds to step 1206, sets the valid storage area 380 to one, registers the data 2182 of the D command 2180 in the data storage area 390, and returns to step 1201. If the command is an ND command 2190, it returns to step 1201.

In step 1207, the CCC device 320 determines whether the valid storage area 380 is one. If the valid storage area 380 is one, it proceeds to step 1214, otherwise it proceeds to step 1208.

In step 1208, it reads the req address from the main memory. Specifically, it sets the req address in the address 2202 and transmits an M command to the main memory 200. Upon receiving the M command 2200, the main memory 200 registers 128-byte data corresponding to the address 2202 in data 2212, and it transmits an MD command 2210 to the directory unit 300. The MD command 2210 that was transmitted to the directory unit 300 is transferred to the CCC device 320 via the receive filter 310. The operation of the receive filter 310 will not be described here because it has already been described.

In step 1209, the CCC device 320 registers the data 2212 of the MD command 2210 in the data storage area 390. In step 1210, it notifies the contracting device 330 of the “not occupied” state and proceeds to step 1211.

In step 1214, it notifies the contracting device 330 of the “occupied” state and proceeds to step 1211.

In step 1211, it obtains a node group to which the req node belongs, by consulting the node group table 370. In step 1212, it sets to one a bit corresponding to the node group obtained in step 1211 of a directory entry corresponding to the req address. In step 1213, it sets the data registered in the data storage area 390 in data 2022, transmits the FC command 2020 to the req node, and proceeds to step 1107.

In step 1107, the CCC device 320 sets the busy storage area 350 to the value zero and waits for a command in step 1100.

(3-4) Operation of the CCC Device when a Processor Issues an FI Command

When a data write instruction executed by the processor 10 causes a cache miss, it is necessary to transfer a relevant cache block to the cache 12 and register the cache block as having state M. Accordingly, the processor 10 sets its own node number in the node number field 2032 of the FI command 2030 and the address of the relevant cache block in the address field 2033, and it transmits the command to the directory unit 300 via the interconnection network 100. After that, the processor 10 waits for an ACK command 2160 or a NACK command 2170 to be transmitted from the directory unit 300. When receiving a NACK command 2170, the processor 10 retransmits the FI command 2030 until receiving the ACK command 2160 without receiving the NACK command 2170. Upon receiving the ACK command 2160, the processor 10 halts the execution of the following instructions until it receives an FIC command 2050.

In the directory unit which has received the FI command 2030, the receive filter 310 operates according to the flowchart of FIG. 8 (the description of which omitted since it has already been described), and, in step 2005, it transfers the received FI command 2030 to the CCC device 320.

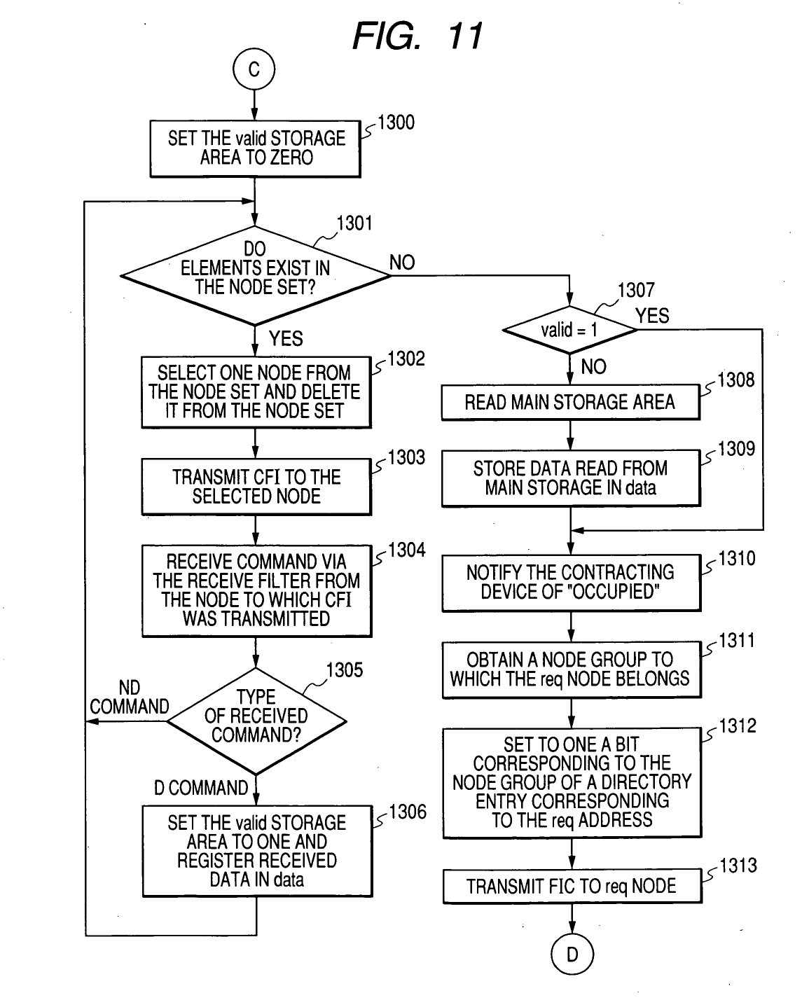

The operation of the CCC device 320 will be described with reference to the flowcharts of FIGS. 9 and 11.

In step 1100, the CCC device 320 receives the FI command 2030 that was transferred from the receive filter 310. In step 1101, it records the received FI command 2030 in the req storage area 360 via the line 406. In step 1102, it reads a directory entry corresponding to the address 2033 (req address) of the FI 10 command 2030 that is recorded in the req storage area 360. In step 1103, it converts the read directory entry into a node set. In step 1106, the CCC device 320 deletes the node number 2032 (req node) of the FI command 2030 that is recorded in the req storage area 360 from the node set. In step 1106, it proceeds to step 1300 by determining the command type 2031 of the FI command 2030 that is recorded in the req storage area 360.

In step 1300, it sets the valid storage area 380 at the value zero. In step 1301, it determines whether elements exist in the node set, and, if elements exist in the node set, it proceeds to step 1302; otherwise, it proceeds to step 1307.

In step 1302, it selects one node from the node set, and it deletes the selected node from the node set. In step 1303, it sets the req address in the address 2042 and transmits the CFI command 2040 to the selected node.

Upon receiving the CFI command 2040, the node checks to determine whether the address 2042 is registered in its own cache. If the address 2042 indicates its own cache and the cache block is in the M state, the node causes the cache block to transition to the S state, sets the data of the cache block in the data 2182, and transmits the D command 2180 to the directory unit 300. If the address 2042 indicates its own cache and the cache block is in the E state, the node causes the cache block to transition to the I state, sets the data of the cache block in the data 2182, and transmits the D command 2180 to the directory unit 300. If the address 2042 indicates its own cache and the cache block is in the S state, the node causes the cache block to transition to the I state, sets the data of the cache block in the data 2182, and transmits the D command 2180 to the directory unit 300. If the address 2042 indicates its own cache and the cache block is in the I state, or the address 2042 is not registered in the cache, the node transmits an ND command 2190 to the directory unit 300. The D command 2180 or ND command 2190 which is transmitted to the directory unit 300 is transferred to the CCC device 320 via the receive filter 310. The operation of the receive filter 310 will not be described here because it has already been described.

Here, the system returns to the operation of the CCC device 320. In step 1304, the CCC device 320 receives the D command 2180 or the ND command 2190. In step 1305, it determines the type of the received command. If the command is a D command 2180, it proceeds to step 1306, sets the valid storage area 380 to one, registers the data 2182 of the D command 2180 in the data storage area 390, and returns to step 1301. If the command is an ND command 2190, it returns to step 1301.

In step 1307, the CCC device 320 determines whether the valid storage area 380 is one. If the valid storage area 380 is one, it proceeds to step 1310, otherwise it proceeds to step 1308.

In step 1308, it reads the req address from the main memory. 10 Specifically, it sets the req address in the address 2202 and transmits an M command to the main memory 200. Upon receiving the N command 2200, the main memory 200 registers 128-byte data corresponding to the address 2202 in data 2212, and it transmits an MD command 2210 to the directory unit 300. The ND command 2210 that was transmitted to the directory unit 300 is transferred to the CCC device 320 via the receive filter 310. The operation of the receive filter 310 will be omitted here because it has already been described.

In step 1309, the CCC device 320 registers the data 2212 of the MD command 2210 in the data storage area 390.

In step 1310, it notifies the contracting device 330 of the “occupied” state. In step 1311, it obtains a node group to which the req node belongs, by consulting the node group table 370. In step 1312, it sets to one a bit corresponding to the node group obtained in step 1311 of a directory entry corresponding to the req address. In step 1313, it sets the data registered in the data storage area 390 in data 2052, transmits the FIC command 2050 to the req node, and proceeds to step 1107.

In step 1107, the CCC device 320 sets the busy storage area 350 to the value zero and waits for a command in step 1100.

(3-5) Operation of the CCC Device when a Processor Issues I Command

When the processor 10 executes a data write instruction for a cache block of the S state, a relevant cache block must be registered as having the state M. Accordingly, the processor 10 sets its own node number in the node number field 2062 of the 1 command 2060 and sets the address of the relevant cache block in the address field 2063, and it transmits the command to the directory unit 300 via the interconnection network 100. After that, the processor 10 waits for an ACK command 2160 or a NACK command 2170 to be transmitted from the directory unit 300. When receiving a NACK command 2170, the processor 10 retransmits the I command 2060 until it receives the ACK command 2160 without receiving the NACK command 2170. Upon receiving the ACK command 2160, the processor 10 halts the execution of the following instructions until receiving an IC command 2080.

In the directory unit which has received the I command 2060, the receive filter 310 operates according to the flowchart of FIG. 8 (the description of which is omitted since it has already been described), and, in step 2005, it transfers the received I command 2060 to the CCC device 320.

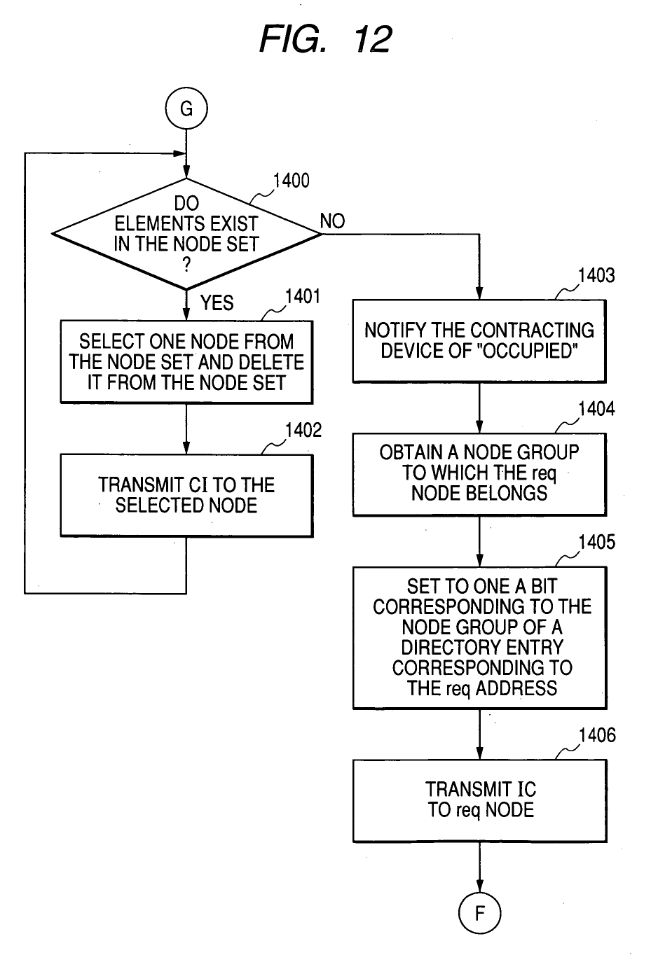

The operation of the CCC device 320 will be described with reference to the flowcharts of FIGS. 9 and 12.

In step 1100, the CCC device 320 receives the I command 2060 that was transferred from the receive filter 310. In step 1101, it records the received I command 2060 in the req storage area 360 via the line 406. In step 1102, it reads a directory entry corresponding to the address 2063 (req address) of the I command 2060 that is recorded in the req storage area 360. In step 1103, it converts the read directory entry into a node set. In step 1106, the CCC device 320 deletes the node number 2062 (req node) of the I command 2060 that is recorded in the req storage area 360 from the node set. In step 1106, it proceeds to step 1400 by determining the command type 2061 of the I command 2060 that is recorded in the req storage area 360.

In step 1400, it determines whether elements exist in the node set, and, if elements exist in the node set, it proceeds to step 1401; otherwise, it proceeds to step 1403.

In step 1401, it selects one node from the node set, and it deletes the selected node from the node set. In step 1402, it sets the req address in the address 2072 and transmits the CI command 2070 to the selected node.

Upon receiving the CI command 2070, the node checks to determine whether the address 2072 is registered in its own cache. If the address 2072 indicates its own cache and the cache block is in the M state, the node causes the cache block to transition to the I state. If the address 2072 indicates its own cache and the cache block is in the E state, the node causes the cache block to transition to the I state. If the address 2072 indicates its own cache and the cache block is in the I state, or the address 2072 is not registered in the cache, the node performs no operation.

Here, the system returns to the operation of the CCC device 320. In step 1403, it notifies the contracting device 330 of the “occupied” state. In step 1404, it obtains a node group to which the req node belongs, by consulting the node group table 370. In step 1405, it sets to one a bit corresponding to the node group obtained in step 1404 of a directory entry corresponding to the req address. In step 1406, it sets the data registered in the data storage area 390 in data 2052, transmits the IC command 2080 to the req node, and proceeds to step 1107.

In step 1107, the CCC device 320 sets the busy storage area 350 the value zero and waits for a command in step 1100.

(3-6) Operation of the CCC Device when a Processor Issues WB Command

When a cache block having the M state that is registered in the cache 12 of the processor 10 transitions to the S or the I state, or is expelled from the cache by being replaced, the cache block must be written back to the main memory 200. Accordingly, the processor sets the address of the cache block in the address 2092 of the WB command 2090 and sets the data of the cache block in the data 2093, and it transmits the WB command to the main memory 200 via the interconnection network 100.

Upon receiving the WB command 2090, the main memory 200 writes the data 2093 to the address 2092.

(3-7) Operation of the CCC Device when a Processor Executes a PageFlush Instruction.

The processor 10 has a PageFlush instruction. The PageFlush instruction flushes all cache blocks in a 4-Kbyte page indicated by an address specified in the operand from all caches in the system 999. By flushing the cache blocks, if the cache blocks have been registered in caches, the cache blocks are deregistered from the caches, while their data is written back to the main memory, as required. Specifically, when a certain address is specified, if a cache block corresponding to the address is in the M state, the data is written back to the main memory and the cache block is caused to transition to the I state; while, if it is in the E or S state, the cache block is caused to transition to the I state.

When the PageFlush instruction has been executed, since it is guaranteed that a relevant page is not registered in any of the caches in the system, a directory entry corresponding to the page is set at the value 0000.

Upon executing the PageFlush instruction, the processor halts access to a relevant page by the following instructions until the flushing of the page by the processor is completed. In this embodiment, all of the following instructions are halted until a PFC command 2120 is received. When other processors have executed the PageFlush instruction, accesses to the page by the following instructions are halted until the page has been flushed by the processor. In this embodiment, all of the following instructions are halted.

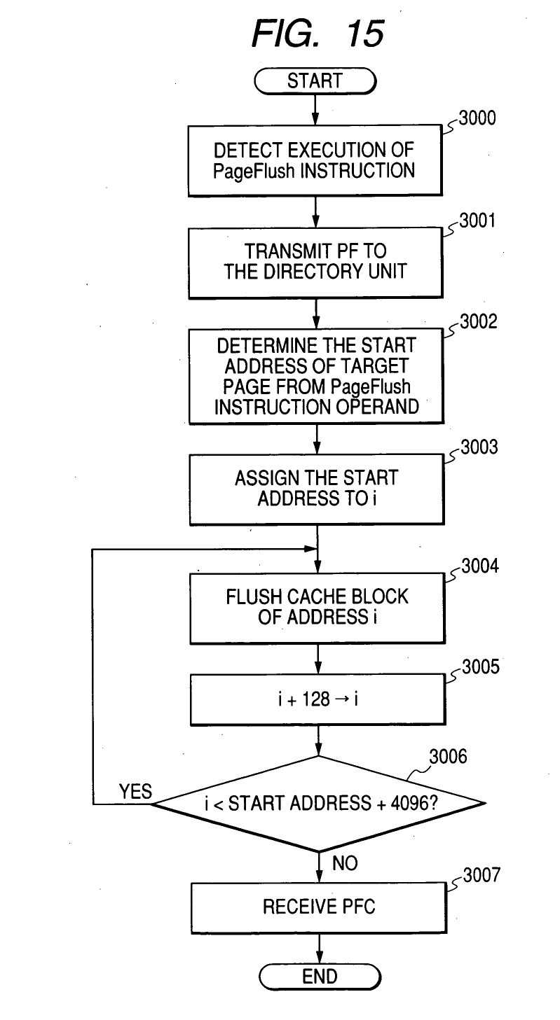

With reference to FIG. 15, a description will be made of the operation of the PF mechanism 13 in the processor 10 that has executed the PageFlush instruction.

In step 3000, the PF mechanism 13 detects the execution of the PageFlush instruction. In step 3001, it sets its own node number in the node number field 2102 of the PF command 2100 and sets an address specified in an operand of the PageFlush instruction in the address field 2103, and it transmits the command to the directory unit 300 via the interconnection network 100. After that, the processor 10 waits for an ACK command 2160 or a NACK command 2170 to be transmitted from the directory unit 300. When it receives a NACK command 2170, the processor 10 retransmits the PF command 2100 until it receives the ACK command 2160 without receiving the HACK command 2170. Upon receiving the ACK command 2160, the processor 10 halts the execution of the following instructions until it receives a PFC command 2120.

In step 3002, the PF mechanism 13 determines the start address of a target page from the address specified in the operand of the PageFlush instruction. If the address specified in the operand is OA, the start address of the target page is calculated by (OA-(OAmod 4096)), where (OAmod 4096) indicates a remainder obtained when OA is divided by 4096.

In step 3003, the start address of the target page determined in step 3002 is assigned to a variable i. In step 3004, a cache block of address i is flushed. In step 3005, the value i+128 is assigned to the variable i. In step 3006, it determines whether the value i is smaller than the start address plus 4096, and, if smaller, the processing proceeds to step 3004, and otherwise it proceeds to step 3007.

In step 3007, a PFC command 2120 is received, and the processing terminates.

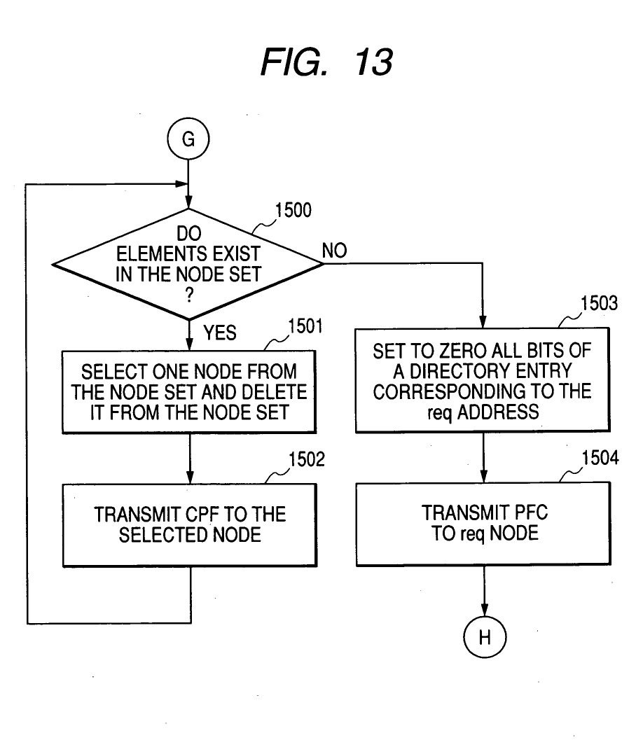

The operation of the CCC device 320, when it receives the PF command 2100, will be described with reference to the flowcharts of FIGS. 9 and 13.

In step 1100, the CCC device 320 receives the PF command 2100 that is transferred from the receive filter 310. In step 1101, it records the received PF command 2100 in the req storage area 360 via the line 406. In step 1102, it reads a directory entry corresponding to the address 2103 (req address) of the PF command 2100 that is recorded in the req storage area 360. In step 1103, it converts the read directory entry into a node set. In step 1106, the CCC device 320 deletes the node number 2102 (req node) of the PP command 2100 that is recorded in the req storage area 360 from the node set. In step 1106, it proceeds to step 1500 by determining the command type 2101 of the PF command 2100 that is recorded in the req storage area 360.

In step 1500, it determines whether elements exist in the node set, and, if elements exist in the node set, the processing proceeds to step 1501; otherwise, it proceeds to step 1503.

In step 1501, it selects one node from the node set, and it deletes the selected node from the node set. In step 1502, it sets the req address in the address 2112 and transmits the CPF command 2110 to the selected node.

In step 1503, it sets all bits of the directory entry corresponding to the req address to zeros (0000). In step 1504, it transmits a PFC command 2120 to the req node, and the processing then proceeds to step 1107.

In step 1107, the busy storage area 350 is set at the value zero, and the CCC device 320 waits for a command in step 1100.

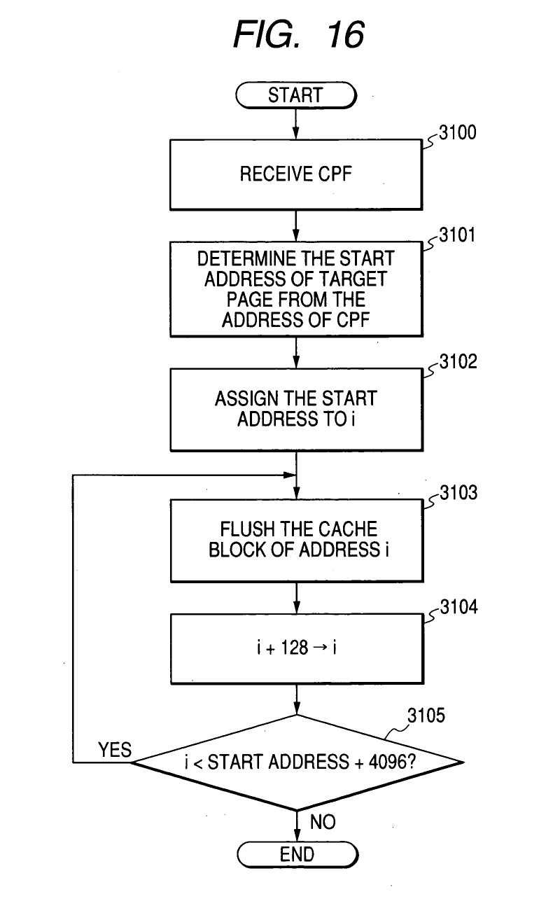

Upon receiving the CPF command 2110, the node transfers it to the PF mechanism 13 of the processor 10. The operation of the PF mechanism 13 that receives the CPF command 2110 will be described with reference to a flowchart of FIG. 16.

In step 3100, the PF mechanism 13 receives the CPF command 2110. In step 3101, it determines the start address of a target page from the address 2112 of the CPF command 2110. The start address of the target page is calculated by (the address 2112 (the address 2112 mod 4096)), where (the address 2112 mod 4096) indicates a remainder obtained when the address 2112 is divided by 4096.

In step 3102, the start address of the target page determined in step 3101 is assigned to a variable i. In step 3103, it flushes a cache block of address i is flushed. In step 3104, the value i+128 is assigned to the variable i. In step 3105, it is determined whether the value i is smaller than the start address plus 4096, and, if smaller, the processing proceeds to step 3103, and otherwise it terminates.

(3-8) Operation of the CCC Device when a Processor Executes a PagePurge Instruction

The processor 10 has a PagePurge instruction. The PagePurge instruction purges all cache blocks in a 4-Kbyte page indicated by an address specified in the operand from all the caches in the system 999. By purging the cache blocks, if the cache blocks have been registered in the caches, the cache blocks are deregistered from the caches without writing their data back to the main memory. Specifically, when a certain address is specified, if a cache block corresponding to the address is in the M state, the E state, or the S state, the cache block is caused to transition to the I state. The purge operation is different from the flush operation in that data is not written back to the main memory, even if the cache block is in the M state.

When the PagePurge instruction has been executed, since it is guaranteed that a relevant page is not registered in any of the caches in the system, a directory entry corresponding to the page is set at the value 0000.

The processor that has executed the PagePurge instruction halts access to the relevant page by the following instructions until the purging of the page by the processor is completed. In this embodiment, all of the following instructions are halted until the PPC command 2150 is received. When other processors have executed the PagePurge instruction, accesses to the relevant page by the following instructions are halted until the purging of the page by the processor is completed. In this embodiment, all of the following instructions are halted.

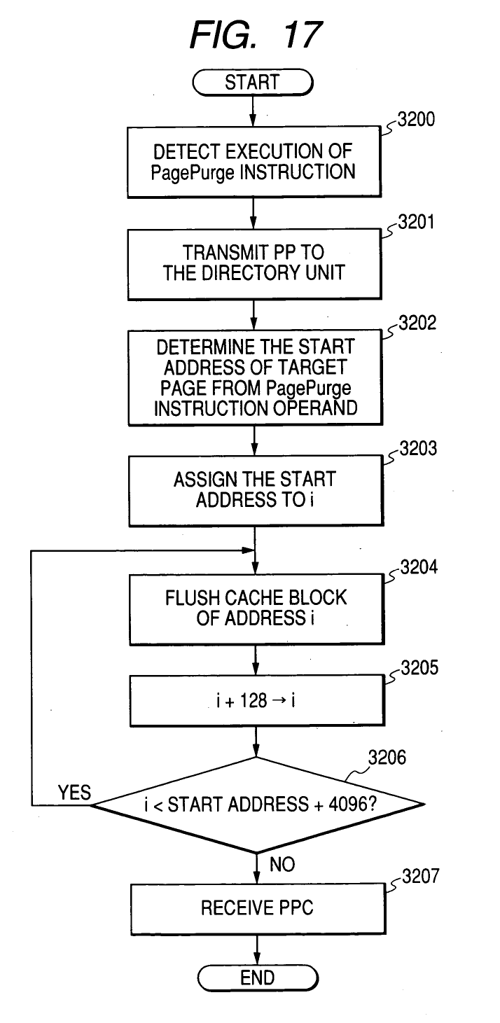

With reference to FIG. 17, a description will be made of 15 the operation of the PP mechanism 14 in the processor 10 that has executed the PagePurge instruction.

In step 3200, the PP mechanism 14 detects the execution of the PagePurge instruction. In step 3201, it sets its own node number in the node number 2132 of the PP command 2130 and sets an address specified in an operand of the PagePurge instruction in the address 2133, and it transmits the command to the directory unit 300 via the interconnection network 100. After that, the processor 10 waits for an ACK command 2160 or a NACK command 2170 to be transmitted from the directory unit 300. When receiving a NACK command 2170, the processor 10 retransmits the PP command 2130 until it receives the ACK command 2160 without receiving the NACK command 2170. Upon receiving the ACK command 2160, the processor 10 halts the execution of the following instructions until it receives a PPC command 2150.

In step 3202, the PP mechanism 14 determines the start address of a target page from the address specified in the operand of the PagePurge instruction. If the address specified in the operand is OA, the start address of the target page is calculated by (OA-(oAmocl 4096)), where (OAmod 4096) indicates a remainder obtained when OA is divided by 4096.

In step 3203, it assigns the start address of the target page determined in step 3203 to a variable i. In step 3204, it purges a cache block of address i. In step 3205, it assigns the value i+128 to the variable i. In step 3206, it determines whether the value i is smaller than the start address plus 4096, and, if smaller, the processing proceeds to step 3204, and otherwise it proceeds to step 3207.

In step 3207, it receives a PPC command 2150, and the processing terminates.

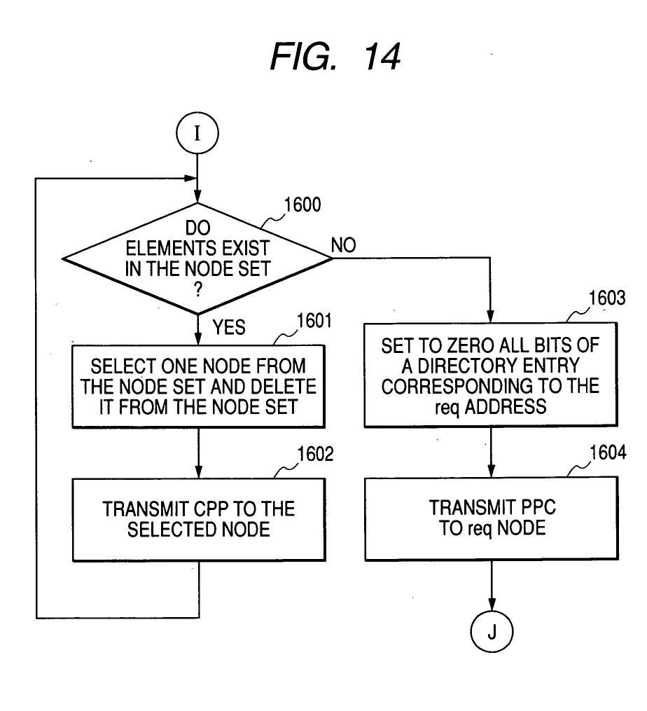

The operation of the CCC device 320, when it receives the PP command 2130, will be described with reference to the flowcharts of FIGS. 9 and 14.

In step 1100, the CCC device 320 receives the PP command 2130 that is transferred from the receive filter 310. In step 1101, it records the received PP command 2130 in the req storage area 360 via the line 406. In step 1102, it reads a directory entry corresponding to the address 2133 (req address) of the PP command 2130 that is recorded in the req storage area 360. In step 1103, it converts the read directory entry into a node set. In step 1106, the CCC device 320 deletes the node number 2132 (req node) of the PF command 2130 that is recorded in the req storage area 360 from the node set. In step 1106, it proceeds to step 1600 by determining that the command type 2131 of the PP command 2130 is recorded in the req storage area 360.

In step 1600, it determines whether elements exist in the node set, and, if elements exist in the node set, the processing proceeds to step 1601; otherwise, it proceeds to step 1603.

In step 1601, one node is selected from the node set, and the selected node is deleted from the node set. In step 1602, the req address is set in the address 2142 and the CPP command 2140 to the selected node.

In step 1603, all bits of directory entry corresponding to the req address and set to zeros (0000). In step 1604, a PPC command 2150 is transmitted to the req node, and the processing proceeds to step 1107.

In step 1107, the busy storage area 350 is set at the value zero, and the CCC device 320 waits for a command in step 1100.

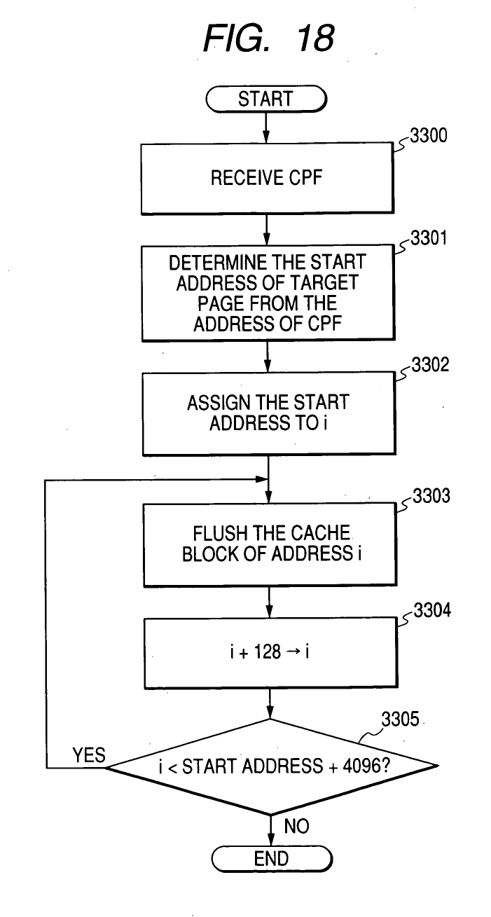

Upon receiving the CPP command 2140, the node transfers it to the PP mechanism 14 of the processor 10. The operation of the PP mechanism 14 that receives the CPP command 2140 will be described with reference to the flowchart of FIG. 18.

In step 3300, the PP mechanism 14 receives the CPP command 2140. In step 3301, it determines the start address of a target page from the address 2142 of the CPP command 2140. The start address of the target page is calculated by (the address 2142 (the address 2142 mod 4096)), where (the address 2142 mod 4096) indicates a remainder obtained when the address 2142 is divided by 4096.

In step 3302, it assigns the start address of the target page determined in step 3301 to a variable i. In step 3303, it flushes a cache block of address i. In step 3304, it assigns the value i+128 to the variable i. In step 3305, it determines whether the value i is smaller than the start address plus 4096, and, if smaller, the processing proceeds to step 3303, and otherwise it terminates.

(3-9) Operation of the Contracting Device

The contracting device 330 detects that one certain node group performs the operation to guarantee that all cache blocks belonging to a certain page are cached in only the node group and not cached in other node groups, and that other node groups do not perform operations for caching the cache blocks belonging to the page, and it sets only a bit corresponding to the node group to one and the remaining three bits to zero in the directory entry corresponding to the page. The contracting device 330 can reduce the number of “one” bits in the directory entry without issuing the PageFlush and PagePurge instructions, thereby to reduce the number of transactions for maintaining cache coherency.

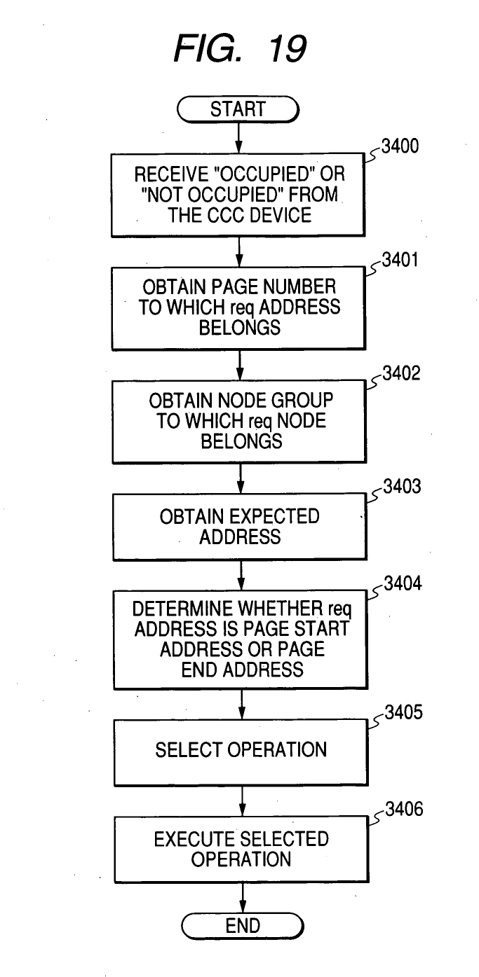

The operation of the contracting device 330 will be described with reference to the flowchart of FIG. 19.

In step 3400, the indication “occupied” or “not occupied” is received from the CCC device 320. “occupied” indicates that, by a command stored in the req storage area 360, a cache block of an address concerned in command issuance (req address) is cached in only a node (req node) that issued the command and is not cached in other nodes. “not occupied” is the reverse of “occupied.”

In step 3401, the contracting device 330 obtains a page number to which the req address belongs. The page number is calculated by (req address—(req address mod 4096))/4096, where (req address mod 4096) indicates a remainder obtained when the req address is divided by 4096.

In step 3402, the contracting device 330 refers to the node group table 370 and obtains a node group to which the req node belongs.

In step 3403, it obtains an expected address. The expected address is zero when the direction storage area 331 is zero, is calculated as (req address—(req address mod 4096))+(counter 334)×128 when the direction storage area is “+” and is calculated as (req address—(req address mod 4096))+3968−(counter 334)×128 when the direction storage area “−.”

In step 3404, it determines whether the req address indicates the start or end of page. Specifically, if (req address mod 4096) is equal to or greater than 0 and equal to or less than 127, the req address indicates the start of a page; whereas, if it is equal to or greater than 3968 and equal to or less than 4095, it indicates the end of a page.

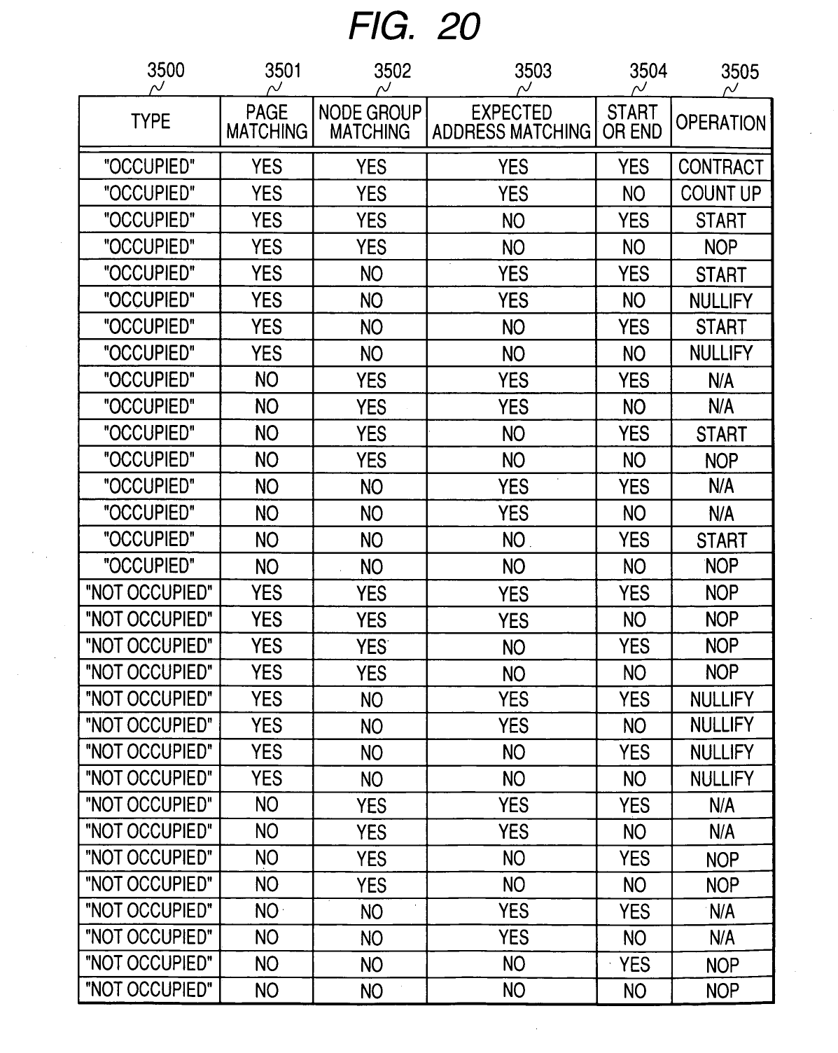

In step 3405, it selects an operation on the basis of the table shown in FIG. 20 by using the following information: the type “occupied” or “not occupied” obtained in step 3400; information indicating whether the page number obtained in step 3401 matches the value of the page storage area 332; information indicating whether the node group obtained in step 3402 matches the value of the node-group storage area 333; information indicating whether the expected value obtained in step 3403 matches the req address; and information indicating whether the req address obtained in step 3404 indicates the start or end of a page. That is, the columns 3500 to 3504 are used as search keys to select an operation of the column 3505. The indicator N/A of operations of the column 3505 denotes an impossible operation for combinations of the columns 3500 to 3504.

In step 3406, the contracting device 330 executes the operation selected in step 3405. If the operation selected in step 3405 is “contract,” it sets to one only a bit corresponding to the node-group storage area 333 in the directory entry corresponding to the page storage area 332, sets the three remaining bits to zero, and sets the direction storage area to zero. If the operation selected in step 3405 is “count up,” it increments the value of the counter 334 by one. If the operation selected in step 3406 is “start,” it sets the direction storage area 331 at “+” if the req address indicates the start of a page, sets the direction storage area 331 at “−” if the req address indicates the end of a page, further sets the page number obtained in step 3401 in the page storage area 332, sets the node group obtained in step 3402 in the node-group storage area 333, and sets the counter 334 at the value one. If the operation selected in step 3405 is “NOP,” it performs no operation.

After execution of step 3406, the contracting device 330 terminates the operation.

1. A processor having a cache memory capable of storing data duplicates of a plurality of first-size cache blocks of an external memory,
wherein the processor includes means, when a second-size data block of the external memory is specified, the second size being a natural multiple (2 or greater) of the first size, for any of cache blocks belonging to the specified data block of the second size, for deleting its data duplicate from the cache memory if stored in the cache memory.

2. A processor including:
a cache memory capable of storing data duplicates of a plurality of first-size cache blocks of an external memory; and
means for deleting a data duplicate of any cache block belonging to a data block specified to be deleted from the cache memory by an instruction specifying the second-size data block from the cache memory if stored in the cache memory, the second size being a natural multiple (2 or greater) of the first size of the external memory.

3. The processor according to claim 2, further including means for outputting the data duplicate deleted from the cache memory outside the processor if necessary.

4. The processor according to claim 2, further including means for requesting other processors to delete data duplicates of cache blocks within a data block specified in the instruction from a corresponding cache memory if stored in the cache memory, by the instruction.

5. A shared-memory multiprocessor system, including:
a plurality of processor nodes each including at least one processor;
a memory shared by the processors of the plurality of processor nodes;
an interconnection network for mutually connecting the plurality of processor nodes and the memory;
a cache memory provided in each of the plurality of processors that is capable of storing data duplicates of a plurality of first-size cache blocks of the memory to speed up memory access of the processor; and
a directory that, for each of second-size data blocks, provided for the memory, the second size being a natural multiple (2 or greater) of the first size, holds information of processors that store a data duplicate of any of cache blocks belonging to the data block in cache memories under their control,
wherein each of the plurality of processors, by one instruction, for any of cache blocks belonging to a data block specified in the instruction, deletes its data duplicate from a cache memory under its control if stored in the cache memory.

6. The shared-memory multiprocessor according to claim 5,
wherein each of the plurality of processors requests other processors to delete a data duplicate of any of cache blocks belonging to a data block specified in the instruction from a corresponding cache memory if stored in the cache memory, by the instruction.

7. The shared-memory multiprocessor according to claim 5,
wherein the plurality of processors is divided into a plurality of processor groups each including at least one processor,
each of entries corresponding to data blocks of the directory contains a train of bits respectively corresponding to the processor groups,
the train of bits indicates whether a data duplicate of any of cache blocks belonging to a corresponding data block is stored or not in a cache memory of any of processors belonging to the respective processor groups, and
the shared-memory multiprocessor system further includes means, for cache blocks belonging to a specified data block, when the operation to delete a data duplicate from a corresponding cache memory has been performed in a processor, for rewriting a train of bits of an entry corresponding to the specified data block of the directory to indicate that the duplicates of the cache blocks belonging to the specified data block are not registered in cache memories of any processors.

8. A shared-memory multiprocessor, including:
a memory;
a plurality of processors each having a cache memory capable of storing data duplicates of a plurality of first-size cache blocks of the memory; and
a directory having entries respectively corresponding to second-size data blocks of the memory, the second size being a natural multiple (2 or greater) of the first size,
wherein the plurality of processors is divided into a plurality of processor groups each including at least one processor,
each entry of the directory contains a train of bits respectively corresponding to the processor groups,
the train of bits indicates whether a data duplicate of any of cache blocks belonging to a corresponding data block is stored or not in a cache memory of any of processors belonging to a corresponding processor group, and
a single instruction starts the operation to rewrite a train of bits of an entry corresponding to a specified data block of the directory so as to indicate that data duplicates of cache blocks belonging to the specified data block are not stored in any of cache memories of the processor groups.

9. A shared-memory multiprocessor, including:
a memory;
a plurality of processors each having a cache capable of storing a plurality of first-size cache blocks of the memory;
a directory having entries respectively corresponding to second-size data blocks of the memory, the second size being a natural multiple (2 or greater) of the first size; and
a directory contracting device,
wherein the plurality of processors is divided into a plurality of processor groups each including at least one processor,
each entry of the directory contains a train of bits respectively corresponding to the processor groups,
the train of bits indicates whether a data duplicate of any of cache blocks belonging to corresponding data blocks is stored or not in a cache memory of any of processors belonging to a corresponding processor group, and
the directory contracting device performs the steps of:
detecting that one of the processor groups performs the operation to guarantee that, for all cache blocks belonging to a certain data block, a data duplicate is stored in only cache memories of the processor group and not in cache memories of other processor groups, and that other processor groups do not perform an operation for storing the data duplicates of the cache blocks belonging to the specific data block in cache memories;
setting only a bit corresponding to the processor group within a train of bits of an entry corresponding to the detected data block of the directory to indicate that a data duplicate of any of cache blocks belonging to the detected data block is stored in a cache memory of any of belonging processors; and
setting other bits to indicate that data duplicates of any cache blocks belonging to the detected data block are not stored in caches of any processors belonging to a corresponding processor group.

10. The shared-memory multiprocessor according to claim 9,
wherein the directory entry contracting device includes a counter initialized when one of the processor groups performs the operation to guarantee that, for a cache block having the smallest address or the largest address that belongs to a certain data block, a data duplicate is stored in only a cache memory of the processor group and not in caches of other processor groups, and performs the detection by counting by use of the counter.
